(19) United States
(12) Patent Application Publication
(10) Pub. No.: US 2018/0169798 A1
(43) Pub. Date: Jun. 21, 2018

(54) BRAZING METHOD FOR ALUMINUM ALLOY BRAZING SHEET

(71) Applicant: KABUSHIKI KAISHA KOBE SEIKO SHO (KOBE STEEL, LTD.), Kobe-shi (JP)

(72) Inventors: Takahiro Izumi, Tochigi (JP); Akihiro Tsuruno, Tochigi (JP); Shimpei Kimura, Tochigi (JP); Nobuhiro Kobayashi, Hyogo (JP)

(73) Assignee: KABUSHIKI KAISHA KOBE SEIKO SHO (KOBE STEEL, LTD.), Kobe-shi (JP)

(21) Appl. No.: 15/834,245

(22) Filed: Dec. 7, 2017

(30) Foreign Application Priority Data
Dec. 16, 2016 (JP) 2016-244919
Mar. 31, 2017 (JP) 2017-072549

(51) Int. Cl. B23K 35/28; B23K 35/02; C22C 21/02; B32B 15/01

(52) U.S. Cl. CPC B23K 35/288; B32B 15/016; C22C 21/02; B23K 35/0238

(57) ABSTRACT

The present invention relates to a brazing method for an aluminum alloy brazing sheet including a core material and a brazing filler material provided in one surface of the core material. The core material includes an aluminum alloy containing Mg: more than 0.5 mass % and 2.5 mass % or less. The brazing filler material includes an aluminum alloy containing Si: 3 mass % or more and 13 mass % or less and Bi: 0.01 mass % or more and 1.00 mass % or less. The brazing method includes brazing the aluminum alloy brazing sheet in an inert gas atmosphere at a heating temperature of 560 to 620° C. without using a flux.

### TECHNICAL FIELD

The present invention relates to a brazing method for an aluminum alloy brazing sheet, and particularly relates to a so-called fluxless brazing method which is a brazing method using no flux.

### BACKGROUND ART

In order to braze a member of a heat exchanger made of an aluminum alloy or the like, there is a method of vacuum brazing, in which brazing is performed using no flux in a vacuum. In comparison with flux brazing using flux, the vacuum brazing has various merits such as unnecessity of treatment for applying flux, avoidance of occurrence of problems caused by an inadequate amount of applied flux, and so on.

However, the vacuum brazing requires an expensive vacuum furnace for heating in a state where the inside of the furnace is evacuated during brazing. Therefore, the working cost is increased. In addition, it is difficult to control the evacuated inside of the furnace. Thus, the working difficulty is also increased.

In order to solve such problems, researches have proceeded on fluxless brazing using no flux under an atmosphere that is not a vacuum, and the following techniques have been proposed.

Specifically, Patent Literature 1 discloses a fluxless brazing method for a heat exchanger having a narrow flow channel inner fin, using an aluminum clad material in which an Al—Si brazing filler material containing, in mass %, 0.1 to 5.0% of Mg and 3 to 13% of Si is disposed in an outermost surface of the aluminum clad material, in which the Al—Si brazing filler material contains Si grains, 25% or more of which have an equivalent circle diameter of 1.75 μm or more out of ones having the diameter of 0.8 μm or more, and in a non-oxidizable atmosphere unattended with decompression, the Al—Si brazing filler material and a member to be brazed are brought into close contact to join the aluminum clad material to the member to be brazed at a heating temperature of 559° C. to 620° C.

In addition, Patent Literature 2 discloses a brazing method for an aluminum material, in which in order to perform brazing using an aluminum alloy brazing sheet, the brazing sheet in which an aluminum alloy containing Mg in an amount of 0.2 mass % or more and 1 mass % or less is used as a core material and the Mg content of a brazing alloy is made 0.05 mass % or less is used, and brazing is performed by using a brazing furnace having at least two chambers, in an inert gas atmosphere and under a heating condition that temperature rising time up to 570° C. after exceeding 200° C. is set within 12 minutes.

Further, Patent Literature 3 discloses a joining/assembling method of aluminum alloy sheet materials, including a fluxless brazing step in an atmosphere controlled by nitrogen and/or argon and at a temperature included between 580° C. and 620° C., and a rapid cooling step, in which at least one of the aluminum alloy sheet materials contains a core material alloy having a composition of, in mass %, 0.3 to 1.0% of Si; 0.3 to 1.0% of Cu; 0.3 to 2.0% of Mn; 0.3 to 3.0% of Mg; one kind or two or more kinds selected from Fe <1.0%, Ti<0.1%, Zr<0.3%, Cr<0.3%, Bi<0.5%, and Y<0.5%, and other elements each <0.05% and 0.15% in total thereof; with the remainder being aluminum, and at least one surface of a brazing aluminum alloy containing 4 to 15% of silicon and 0.01 to 0.5% of at least one element of Bi and Y, is coated with the aluminum alloy sheet material.

### CITATION LIST

### Patent Literature

Patent Literature 1: Japanese Patent No. 5619538

Patent Literature 2: Japanese Patent No. 4537019

Patent Literature 3: Japanese Patent No. 4996255

### SUMMARY OF THE INVENTION

### Problem that the Invention is to Solve

Each technique according to Patent Literatures 1 to 3 is a technique about fluxless brazing in an inert gas atmosphere that is not a vacuum. Each literature has examined a predetermined effect. However, in the technique according to Patent Literature 1, 0.1 to 5.0 mass % of Mg is contained in a brazing filler material and the Mg promotes generation of MgO in a surface of the brazing filler material during a temperature rise of brazing heating. As a result, in the technique according to Patent Literature 1, there is a fear that the MgO in the surface of the brazing filler material may become an obstacle when a brazing filler is melted, thereby deteriorating brazeability.

In the technique according to Patent Literature 2, little Mg is contained in a brazing filler material, but Mg is contained in a core material (Examples of Patent Literature 2). In a temperature rise process during brazing heating, the Mg of the core material is diffused into the brazing filler material, and a part of the diffused Mg arrives at a surface of the brazing filler material. Thus, MgO is generated in the surface of the brazing filler material. As a result, in the technique according to Patent Literature 2, there is a fear that the MgO in the surface of the brazing filler material may become an obstacle when a brazing filler is melted, thereby deteriorating brazeability.

In the technique according to Patent Literature 3, Mg is contained in a core material in the same manner as in Patent Literature 2. However, the content is as small as 0.47 mass % or 0.49 mass % (Examples of Patent Literature 3) and thus a satisfactory getter action due to Mg contained cannot be exhibited. The getter action means an action in which Mg, during evaporating into an atmosphere, breaks an oxide film formed in the surface of the brazing filler material while the Mg reacts with oxygen to thereby reduce the oxygen concentration in the atmosphere. As a result, in the technique according to Patent Literature 3, there is a fear that reoxidation of a molten brazing filler may not be suppressed satisfactorily, thereby deteriorating brazeability.

Therefore, an object of the present invention is to provide a brazing method for an aluminum alloy brazing sheet capable of exhibiting excellent brazeability.

### Means for Solving the Problem

That is, a brazing method for an aluminum alloy brazing sheet according to the present invention is a brazing method for an aluminum alloy brazing sheet including a core material and a brazing filler material provided in one surface of the core material, in which the core material includes an aluminum alloy containing Mg: more than 0.5 mass % and 2.5 mass % or less, and the brazing filler material includes an aluminum alloy containing Si: 3 mass % or more and 13 mass % or less and Bi: 0.01 mass % or more and 1.00 mass % or less, and the blazing method includes brazing the aluminum alloy brazing sheet in an inert gas atmosphere at a heating temperature of 560 to 620° C. without using a flux.

In this manner, in the brazing method for the aluminum alloy brazing sheet according to the present invention, contents of components (particularly the content of Mg) in the core material of the aluminum alloy brazing sheet to be used are specified, and contents of components (particularly the content of Bi) in the brazing filler material are specified. Accordingly, Mg diffused from the core material into the brazing filler material reacts with Bi of the brazing filler material (to be trapped), so as to suppress generation of MgO in the surface of the brazing filler material. Further, when a brazing filler is melted during brazing heating, the Mg reacting with Bi is dissolved in a matrix (brazing filler material) to promote evaporation of the Mg. Thus, an oxide film formed in the surface of the brazing filler material is broken suitably during the evaporation of Mg, and the oxygen concentration in the atmosphere is reduced to suppress reoxidation of the molten brazing filler. In addition, the Bi dissolved in the matrix enhances flowability of the molten brazing filler. As a result, in the brazing method for the aluminum alloy brazing sheet according to the present invention, it is possible to exhibit excellent brazeability in the inert gas atmosphere without using flux.

In addition, in the brazing method for the aluminum alloy brazing sheet according to the present invention, the brazing filler material may further contain Mg: 0.10 mass % or less. In addition, in the brazing method for the aluminum alloy brazing sheet according to the present invention, the brazing filler material may further contain one or more kinds of Mn: 2.0 mass % or less, Ti: 0.3 mass % or less, Cr: 0.3 mass % or less, and Zr: 0.3 mass or less. In addition, in the brazing method for the aluminum alloy brazing sheet according to the present invention, the brazing filler material may further contain Li: 0.3 mass % or less. In addition, in the brazing method for the aluminum alloy brazing sheet according to the present invention, the brazing filler material may further contain Zn: 5.0 mass % or less. In addition, in the brazing method for the aluminum alloy brazing sheet according to the present invention, the brazing filler material may further contain one or more kinds of Sr: 0.10 mass % or less, Na: 0.050 mass % or less and Sb: 0.5 mass % or less. In addition, in the brazing method for the aluminum alloy brazing sheet according to the present invention, the brazing filler material may further contain a rare earth element: 1.0 mass % or less.

In this manner, in the brazing method for the aluminum alloy brazing sheet according to the present invention, excellent brazeability can be exhibited even when the brazing filler material contains Mg, Mn, Ti, Cr, Zr, Li, Zn, Sr, Na, Sb, or rare earth elements.

In addition, in the brazing method for the aluminum alloy brazing sheet according to the present invention, the core material may further contain Cu: 1.0 mass % or less. In addition, in the brazing method for the aluminum alloy brazing sheet according to the present invention, the core material may further contain Si: 1.0 mass % or less. In addition, in the brazing method for the aluminum alloy brazing sheet according to the present invention, the core material may further contain Mn: 2.5 mass % or less. In addition, in the brazing method for the aluminum alloy brazing sheet according to the present invention, the core material may further contain Fe: 1.5 mass % or less. In addition, in the brazing method for the aluminum alloy brazing sheet according to the present invention, the core material may further contain one or more kinds of Ti: 0.5 mass % or less, Cr: 0.5 mass % or less and Zr: 0.5 mass % or less. In addition, in the brazing method for the aluminum alloy brazing sheet according to the present invention, the core material may further contain Li: 0.3 mass % or less.

In this manner, in the brazing method for the aluminum alloy brazing sheet according to the present invention, excellent brazeability can be exhibited even when the core material contains Cu, Si, Mn, Fe, Ti, Cr, Zr, or Li.

### Advantage of the Invention

In a brazing method for an aluminum alloy brazing sheet according to the present invention, each of the contents of components of a core material and a brazing filler material in the aluminum alloy brazing sheet to be used are specified so that excellent brazeability can be exhibited.

### BRIEF DESCRIPTION OF THE DRAWINGS

FIG. 1 is a sectional view of an aluminum alloy brazing sheet according to an embodiment of the present invention.

FIG. 2 is a perspective view illustrating a state in which a fin material has been brazed and joined to a test piece in evaluation of brazeability.

FIG. 3 is a view for explaining a joined part and an unjoined part and is a view of a surface of the test piece after the fin material has been separated from the test piece in the evaluation of brazeability.

### MODE FOR CARRYING OUT THE INVENTION

A mode (embodiment) for carrying out a brazing method for an aluminum alloy brazing sheet according to the present invention will be described below referring to the drawings in accordance with necessity.

First, the aluminum alloy brazing sheet (hereinafter referred to as “brazing sheet” as necessary) for use in the brazing method (hereinafter referred to as “brazing method” as necessary) for the aluminum alloy brazing sheet according to the present embodiment will be described.

### [Aluminum Alloy Brazing Sheet]

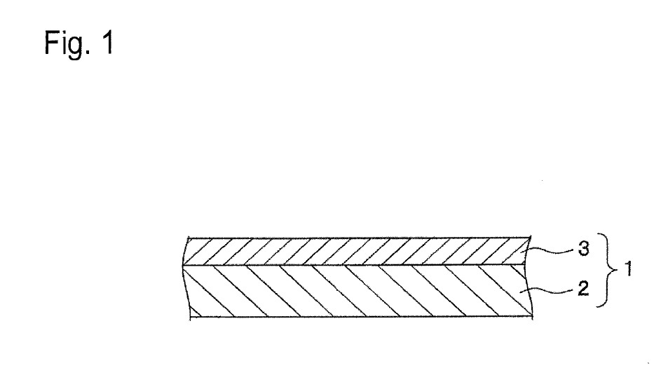

A configuration of the brazing sheet according to the present embodiment is, for example, provided with a core material 2, and a brazing filler material 3 provided on one surface of the core material 2, as illustrated in FIG. 1. In the brazing sheet 1 according to the present embodiment, each of the contents of components of the core material 2 and the brazing filler material 3 are specified. The reason why the numerical values of the components of the core material and the brazing filler material in the brazing sheet according to the present embodiment are restricted will be described below in detail.

### [Core Material]

The core material of the brazing sheet according to the present embodiment is made of an aluminum alloy containing Mg: more than 0.5 mass % and 2.5 mass % or less. An Al—Cu alloy of JIS 2000 series, an Al—Mn alloy of JIS 3000 series, an Al—Mg alloy of JIS 5000 series, an Al—Mg—Si alloy of JIS 6000 series, etc. can be used as such an aluminum alloy. In addition, the core material of the brazing sheet according to the present embodiment may further contain Cu: 1.0 mass % or less, may further contain Si: 1.0 mass % or less, may further contain Mn: 2.5 mass % or less, and may further contain Fe: 1.5 mass % or less. In addition, the core material of the brazing sheet according to the present embodiment may further contain one or more kinds of Ti: 0.5 mass % or less, Cr: 0.5 mass % or less and Zr: 0.5 mass % or less, and may further contain Li: 0.3 mass % or less.

(Mg in Core Material: More than 0.5 Mass % and 2.5 Mass % or Less)

Mg of the core material is diffused into the brazing filler material in a material production step and in a temperature rise process up to a melting starting temperature of a brazing filler during brazing heating. The Mg diffused in the brazing filler material evaporates into an atmosphere at a melting temperature of the brazing filler during the brazing heating and reacts with oxygen in the atmosphere. As a result, an oxide film formed in the surface of the brazing filler material is favorably broken during the evaporation of Mg, while the oxygen concentration in the atmosphere is reduced to suppress reoxidation of the molten brazing filler (to obtain a getter action) to thereby improve the brazeability. When the Mg content of the core material is 0.5 mass % or less, the getter action is insufficient and brazeability lowers. On the contrary, when the Mg content of the core material exceeds 2.5 mass %, the Mg cannot be trapped satisfactorily by Bi of the brazing filler material, which will be described later. Thus, generation of MgO is promoted in the surface of the brazing filler material to lower the brazeability. Accordingly, the Mg content of the core material is more than 0.5 mass % and 2.5 mass or less.

In order to more surely secure the getter action obtained by incorporating Mg, it is preferable that the Mg content of the core material is 1.1 mass % or more.

### (Cu in Core Material: 1.0 Mass % or Less)

Cu of the core material makes the potential of the core material noble to thereby improve corrosion resistance. However, when the Cu content exceeds 1.0 mass %, the solidus temperature of the core material is decreased. Accordingly, erosion resistance deteriorates and flowability of the brazing filler deteriorates, and thus, brazeability deteriorates. Therefore, when Cu is contained in the core material, the Cu content is 1.0 mass % or less.

In order to more surely secure the effect (improvement of corrosion resistance) obtained by incorporating Cu, the Cu content of the core material is preferably 0.05 mass % or more. In addition, in order to suppress deterioration in brazeability, the Cu content of the core material is preferably 0.5 mass % or less, and more preferably less than 0.3 mass %.

### (Si in Core Material: 1.0 Mass % or Less)

Si of the core material improves strength. However, when the Si content exceeds 1.0 mass %, the solidus temperature of the core material is decreased. Accordingly, erosion resistance deteriorates and flowability of the brazing filler deteriorates, and thus, brazeability deteriorates. Therefore, when Si is contained in the core material, the Si content is 1.0 mass % or less.

In order to more surely secure the effect (improvement of strength) obtained by incorporating Si, the Si content of the core material is preferably 0.05 mass % or more.

### (Mn in Core Material: 2.5 Mass % or Less)

Mn of the core material improves strength. When the Mn content is 2.5 mass or less, crystallization of a huge intermetallic compound can be suppressed during casting, so that it is possible to reduce a fear of impairing production or a fear of lowering plastic workability. Therefore, when Mn is contained in the core material, the Mn content of the core material is 2.5 mass % or less.

In order to improve the strength more, the Mn content of the core material is preferably 0.05 mass % or more, and more preferably 0.5 mass % or more.

### (Fe in Core Material: 1.5 Mass % or Less)

Fe of the core material improves strength due to its solid-solution hardening effect. However, when the Fe content exceeds 1.5 mass %, a coarse intermetallic compound may be formed to lower formability. Therefore, when Fe is contained in the core material, the Fe content is 1.5 mass % or less.

In order to more surely secure the effect (improvement of strength) obtained by incorporating Fe, the Fe content of the core material is preferably 0.05 mass % or more.

### (Ti in Core Material: 0.5 Mass % or Less)

Ti of the core material makes the potential of the core material noble to improve corrosion resistance. However, when the Ti content exceeds 0.5 mass %, a coarse intermetallic compound may be formed to lower formability. Therefore, when Ti is contained in the core material, the Ti content is 0.5 mass % or less.

In order to more surely secure the effect (improvement of corrosion resistance) obtained by incorporating Ti, the Ti content of the core material is preferably 0.01 mass % or more.

### (Cr in Core Material: 0.5 Mass % or Less)

Cr of the core material forms Al—Cr dispersed grains to improve the strength of the core material. However, when the Cr content exceeds 0.5 mass %, a coarse intermetallic compound may be formed to lower formability. Therefore, when Cr is contained in the core material, the Cr content is 0.5 mass % or less.

In order to more surely secure the effect (improvement of strength) obtained by incorporating Cr, the Cr content of the core material is preferably 0.01 mass % or more.

### (Zr in Core Material: 0.5 Mass % or Less)

Zr of the core material forms Al—Zr dispersed grains to improve the strength of the core material. However, when the Zr content exceeds 0.5 mass %, a coarse intermetallic compound may be formed to lower formability. Therefore, when Zr is contained in the core material, the Zr content is 0.5 mass % or less.

In order to more surely secure the effect (improvement of strength) obtained by incorporating Zr, the Zr content of the core material is preferably 0.01 mass % or more.

Even when one or more kinds of the aforementioned Ti, Cr and Zr of the core material are contained, that is, even when not only one kind but two or more kinds thereof are contained in the core material, as long as they do not exceed the aforementioned upper limit values, the effect of the present invention is not impaired.

### (Li in Core Material: 0.3 Mass % or Less)

Li of the core material improves brazeability further. A detailed mechanism with which Li improves brazeability have not been clarified yet. It is supposed that Li breaks an oxide film formed in the surface of the brazing filler material to activate the getter action of Mg more suitably when the brazing filler is melted during brazing heating. However, when the Li content exceeds 0.3 mass %, Li is diffused into a surface layer part of the brazing filler material to promote growth of the oxide film in a temperature rise process during the brazing heating. Thus, the brazeability deteriorates. Therefore, when Li is contained in the core material, the Li content is 0.3 mass % or less.

### (Remainder of Core Material: Al and Unavoidable Impurities)

It is preferable that the remainder of the core material is Al and unavoidable impurities. Examples of the unavoidable impurities of the core material may include V, Ni, Ca, Na, Sr, etc. Those elements may be contained as long as they do not impair the effect of the present invention. In particular, they may be contained within ranges of V: 0.05 mass % or less, Ni: 0.05 mass % or less, Ca: 0.05 mass % or less, Na: 0.05 mass % or less, Sr: 0.05 mass % or less, and other elements: less than 0.01 mass %. Not only when those elements are contained as unavoidable impurities but also when they are added positively, they do not impair the effect of the present invention but are allowed as long as they do not exceed the aforementioned predetermined contents. In addition, the aforementioned elements Cu, Si, Mn, Fe, Ti, Cr, Zr, and Li may be added positively, but they may be contained as unavoidable impurities.

### [Brazing Filler Material]

The brazing filler material of the brazing sheet according to the present embodiment is made of an aluminum alloy containing Si: 3 mass % or more and 13 mass % or less, and Bi: 0.01 mass % or more and 1.00 mass % or less. An Al—Si alloy, an Al—Si—Zn alloy, etc. of JIS 4000 series may be used as such an aluminum alloy. In addition, the brazing filler material of the brazing sheet according to the present embodiment may further contain Mg: 0.10 mass % or less, and may further contain one or more kinds of Mn: 2.0 mass % or less, Ti: 0.3 mass % or less, Cr: 0.3 mass % or less, and Zr: 0.3 mass % or less. In addition, the brazing filler material of the brazing sheet according to the present embodiment may further contain Li: 0.3 mass % or less, and may further contain Zn: 5.0 mass % or less. In addition, the brazing filler material of the brazing sheet according to the present embodiment may further contain one or more kinds of Sr: 0.10 mass % or less, Na: 0.050 mass % or less, and Sb: 0.5 mass % or less, and may further contain rare earth elements: 1.0 mass % or less.

### (Si in Brazing Filler Material: 3 Mass % or More and 13 Mass % or Less)

Si of the brazing filler material lowers the solidus temperature of the brazing filler material to improve a liquid phase rate at a brazing heating temperature to thereby enhance the flowability of the brazing filler. When the Si content is 3 mass % or more, the flowability of the brazing filler can be enhanced to obtain an effect of improving the brazeability. On the contrary, when the Si content exceeds 13 mass %, coarse Si grains are formed, and a flowable brazing filler is generated excessively. Thus, there is a fear that a failure in brazing such as melting of the core material may occur. Accordingly, the Si content of the brazing filler material is 3 mass % or more and 13 mass % or less.

### (Bi in Brazing Filler Material: 0.01 Mass % or More and 1.00 Mass % or Less)

Bi of the brazing filler material reacts with Mg of the core material diffused into the brazing filler material during a material production step and during a temperature rise process up to the melting starting temperature of the brazing filler during brazing heating. Thus, an Mg—Bi compound (such as Bi₂Mg₃) is generated to trap the Mg therein. In this manner, a major part of the Mg diffused from the core material into the brazing filler material is trapped by the Bi before the Mg reaches the surface of the brazing filler material, so as to suppress generation/growth of MgO in the surface of the brazing filler material to thereby improve the brazeability. In addition, the Mg—Bi compound is dissolved into the matrix (brazing filler material) at the melting temperature of the brazing filler during the brazing heating. Thus, evaporation of the Mg is promoted so that an oxide film formed in the surface of the brazing filler material can be broken suitably during the evaporation of Mg, while the oxygen concentration in the atmosphere is reduced to improve an action (getter action) of suppressing reoxidation of the molten brazing filler to thereby improve the brazeability. Further, Bi of the brazing filler material enhances the flowability of the brazing filler to improve the brazeability. When the Bi content of the brazing filler material is less than 0.01 mass %, the aforementioned action is insufficient to lower the brazeability. On the contrary, when the Bi content of the brazing filler material exceeds 1.00 mass %, there is a fear that hot rolling cracks may occur in the material production step. Thus, it is difficult to produce the material. Accordingly, the Bi content of the brazing filler material is 0.01 mass % or more and 1.00 mass % or less.

In order to more surely secure the effects (trapping the Mg, promoting the getter action, and improving the flowability of the brazing filler) obtained by incorporating Bi, the Bi content of the brazing filler material is preferably more than 0.20 mass %, and more preferably 0.30 mass % or more. In addition, in order to suppress occurrence of hot rolling cracks, the Bi content of the brazing filler material is preferably 0.80 mass % or less, and more preferably 0.60 mass % or less.

### (Mg in Brazing Filler Material: 0.10 Mass % or Less)

Mg of the brazing filler material evaporates into the atmosphere to react with oxygen during brazing heating. Thus, not only an oxide film formed in the surface of the brazing filler material can be broken, but also the oxygen concentration in the atmosphere can be reduced to suppress reoxidation of the molten brazing filler. Thus, the brazeability can be improved. It is highly likely that the aforementioned Mg diffused from the core material into the brazing filler material may be trapped by Bi before the Mg reaches the surface of the brazing filler material. However, some Mg contained in the brazing filler material is located near the surface of the brazing filler material during the brazing heating, and therefore, is hardly trapped by Bi. When the Mg content exceeds 0.10 mass %, it is likely that generation of MgO in the surface of the brazing filler material may be promoted, and there is a fear that the brazeability may be lowered. Accordingly, when Mg is contained in the brazing filler material, the Mg content of the brazing filler material is 0.10 mass % or less.

In order to suppress generation of MgO in the surface of the brazing filler material, the Mg content of the brazing filler material is preferably less than 0.05 mass %.

### (Mn in Brazing Filler Material: 2.0 Mass % or Less)

Mn of the brazing filler material improves corrosion resistance. A detailed mechanism with which Mn improves corrosion resistance have not been clarified yet. It is supposed that an Al—Mn—Si compound is generated, and an Mn/Si-depleted layer around the compound serves as a less-noble potential part, in which corrosion advances preferentially so that corrosion can be dispersed to improve the corrosion resistance. However, when the Mn content exceeds 2.0 mass %, Si is consumed for generating the Al—Mn—Si compound to reduce the Si concentration. Thus, the brazeability deteriorates.

Therefore, when Mn is contained in the brazing filler material, the Mn content of the brazing filler material is 2.0 mass % or less.

In order to more surely secure the effect of improvement of corrosion resistance obtained by incorporating Mn, the Mn content of the brazing filler material is preferably 0.05 mass % or more. In addition, in order to suppress deterioration in brazeability caused by reduction in Si concentration, the Mn content of the brazing filler material is preferably 1.2 mass % or less.

### (Ti in Brazing Filler Material: 0.3 Mass % or Less)

Ti of the brazing filler material improves corrosion resistance. A detailed mechanism with which Ti improves corrosion resistance have not been clarified yet. It is supposed that an Al—Ti compound is generated, and a Ti-depleted layer around the compound serves as a less-noble potential part, in which corrosion advances preferentially so that corrosion can be dispersed to improve the corrosion resistance. However, when the Ti content exceeds 0.3 mass %, a coarse compound is generated during dissolving and casting. Thus, cracks may occur easily during material production, and the production may be difficult. Therefore, when Ti is contained in the brazing filler material, the Ti content of the brazing filler material is 0.3 mass % or less.

In order to more surely secure the effect of improvement of corrosion resistance obtained by incorporating Ti, the Ti content of the brazing filler material is preferably 0.05 mass % or more. In addition, in order to suppress occurrence of cracks during the material production, the Ti content of the brazing filler material is preferably 0.2 mass % or less.

### (Cr in Brazing Filler Material: 0.3 Mass % or Less)

Cr of the brazing filler material improves corrosion resistance. A detailed mechanism with which Cr improves corrosion resistance have not been clarified yet. It is supposed that an Al—Cr compound or an Al—Cr—Si compound is generated, and a Cr/Si-depleted layer around the compound serves as a less-noble potential part, in which corrosion advances preferentially so that corrosion can be dispersed to improve the corrosion resistance. However, when the Cr content exceeds 0.3 mass %, a coarse compound is generated during dissolving and casting. Thus, cracks may occur easily during material production, and the production may be difficult. Therefore, when Cr is contained in the brazing filler material, the Cr content of the brazing filler material is 0.3 mass % or less.

In order to more surely secure the effect of improvement of corrosion resistance obtained by incorporating Cr, the Cr content of the brazing filler material is preferably 0.05 mass % or more. In addition, in order to suppress occurrence of cracks during the material production, the Cr content of the brazing filler material is preferably 0.2 mass % or less.

### (Zr in Brazing Filler Material: 0.3 Mass % or Less)

Zr of the brazing filler material improves corrosion resistance. A detailed mechanism with which Zr improves corrosion resistance have not been clarified yet. It is supposed that an Al—Zr compound is generated, and a Zr-depleted layer around the compound serves as a less-noble potential part, in which corrosion advances preferentially so that corrosion can be dispersed to improve the corrosion resistance. However, when the Zr content exceeds 0.3 mass %, a coarse compound is generated during dissolving and casting. Thus, cracks may occur easily during material production, and the production may be difficult. Therefore, when Zr is contained in the brazing filler material, the Zr content of the brazing filler material is 0.3 mass % or less.

In order to more surely secure the effect of improvement of corrosion resistance obtained by incorporating Zr, the Zr content of the brazing filler material is preferably 0.05 mass % or more. In addition, in order to suppress occurrence of cracks during the material production, the Zr content of the brazing filler material is preferably 0.2 mass % or less.

Even when one or more kinds of the aforementioned Mn, Ti, Cr, and Zr of the brazing filler material are contained, that is, even when not only one kind but two or more kinds thereof are contained in the brazing filler material, as long as they do not exceed the aforementioned upper limit values, the effect of the present invention is not impaired.

### (Li in Brazing Filler Material: 0.3 Mass % or Less)

Li of the brazing filler material improves brazeability further in the same manner as Li of the core material. A detailed mechanism with which Li improves brazeability have not been clarified yet. It is supposed that Li breaks an oxide film formed in the surface of the brazing filler material to activate the getter action of Mg more suitably when the brazing filler is melted during brazing heating. However, when the Li content exceeds 0.3 mass %, Li promotes growth of the oxide film to deteriorate the brazeability. Therefore, when Li is contained in the brazing filler material, the Li content is 0.3 mass % or less.

### (Zn in Brazing Filler Material: 5.0 Mass % or Less)

Zn of the brazing filler material can make the potential of the brazing filler material less noble to thereby form a potential difference from the core material. Thus, corrosion resistance can be improved due to a sacrificial protection effect. However, there is a fear that the Zn content exceeding 5.0 mass % may lead to early corrosion of a fillet. Therefore, when Zn is contained in the brazing filler material, the Zn content is 5.0 mass % or less.

In order to more surely secure the effect (improvement of corrosion resistance) obtained by incorporating Zn, the Zn content of the brazing filler material is preferably 0.1 mass % or more.

### (Sr in Brazing Filler Material: 0.10 Mass % or Less)

Sr of the brazing filler material refines eutectic Si to thereby suppress crystallization of coarse Si grains causing melting of the core material during brazing heating. However, when the Sr content exceeds 0.10 mass %, there is a fear that flowability of the brazing filler may be lowered to form a fillet insufficiently during the brazing heating. Therefore, when Sr is contained in the brazing filler material, the Sr content is 0.10 mass % or less.

In order to more surely secure the effect (refining of eutectic Si) obtained by incorporating Sr, the Sr content of the brazing filler material is preferably 0.001 mass % or more.

### (Na in Brazing Filler Material: 0.050 Mass % or Less)

Na of the brazing filler material refines eutectic Si to thereby suppress crystallization of coarse Si grains causing melting of the core material during brazing heating. However, when the Na content exceeds 0.050 mass %, there is a fear that flowability of the brazing filler may be lowered to form a fillet insufficiently during the brazing heating. Therefore, when Na is contained in the brazing filler material, the Na content is 0.050 mass % or less.

In order to more surely secure the effect (refining of eutectic Si) obtained by incorporating Na, the Na content of the brazing filler material is preferably 0.0001 mass or more.

### (Sb in Brazing Filler Material: 0.5 Mass % or Less)

Sb of the brazing filler material refines eutectic Si to thereby suppress crystallization of coarse Si grains causing melting of the core material during brazing heating. However, when the Sb content exceeds 0.5 mass %, there is a fear that flowability of the brazing filler may be lowered to form a fillet insufficiently during the brazing heating. Therefore, when Sb is contained in the brazing filler material, the Sb content is 0.5 mass % or less.

In order to more surely secure the effect (refining of eutectic Si) obtained by incorporating Sb, the Sb content of the brazing filler material is preferably 0.001 mass % or more.

Even when one or more kinds of the aforementioned Sr, Na and Sb of the brazing filler material are contained, that is, even when not only one kind but two or more kinds thereof are contained in the brazing filler material, as long as they do not exceed the aforementioned upper limit values, the effect of the present invention is not impaired.

### (Rare Earth Element: 1.0 Mass % or Less)

A rare earth element is a generic term of 17 elements including Sc and Y belonging to the group 3 in the periodic table and lanthanoids (15 elements). Examples of rare earth elements include Sc, Y, La, Ce, Nd, Dy, etc. When a rare earth element is contained in the brazing filler material, one kind thereof may be contained, or two or more kinds thereof may be contained. A method for containing a rare earth element in the brazing filler material is not limited especially. For example, an Al-rare-earth-element intermediate alloy may be added or a misch metal may be added so that two or more kinds of rare earth elements can be contained simultaneously.

Due to reaction between an oxide film (Al₂O₃) in the surface of the brazing filler material and a rare earth element or an oxide containing the rare earth element during brazing heating, volumetric shrinkage occurs in the oxide film in the surface of the brazing filler material to thereby break the oxide film, and thus, a rare earth element of the brazing filler material improves brazeability. However, the content of the rare earth element (the total content thereof when two or more kinds are contained) exceeds 1.0 mass %, the oxide film containing the rare earth element is generated excessively to reduce the effect of breaking the oxide film. Thus, the brazeability deteriorates. Therefore, when a rare earth element is contained in the brazing filler material, the content of the rare earth element (the total content thereof when two or more kinds are contained) is 1.0 mass % or less.

In order to more surely secure the effect (breaking an oxide film) obtained by incorporating a rare earth element, the content of the rare earth element (the total content thereof when two or more kinds are contained) of the brazing filler material is preferably 0.001 mass % or more.

### (Remainder of Brazing Filler Material: Al and Unavoidable Impurities)

It is preferable that the remainder of the brazing filler material is Al and unavoidable impurities. Examples of the unavoidable impurities of the brazing filler material may include Fe, Ca, Be, etc. Those elements may be contained as long as they do not impair the effect of the present invention. In particular, they may be contained within ranges of Fe: 0.35 mass % or less, Ca: 0.05 mass % or less, Be: 0.01 mass % or less, and other elements: less than 0.01 mass %. Not only when those elements are contained as unavoidable impurities but also when they are added positively, they do not impair the effect of the present invention but are allowed as long as they do not exceed the aforementioned predetermined contents. In addition, the aforementioned elements Mg, Mn, Ti, Cr, Zr, Li, Zn, Sr, Na, Sb, and rare earth elements may be added positively, but they may be contained as unavoidable impurities.

### [Thickness of Aluminum Alloy Brazing Sheet]

The thickness of the brazing sheet according to the present embodiment is not limited especially. When it is used as a tube material, the thickness thereof is preferably 0.5 mm or less and more preferably 0.4 mm or less, and preferably 0.05 mm or more. When the brazing sheet according to the present embodiment is used as a side support material, a header material or a tank material, the thickness thereof is preferably 2.0 mm or less and more preferably 1.5 mm or less, and preferably 0.5 mm or more. In addition, when the brazing sheet according to the present embodiment is used as a fin material, the thickness thereof is preferably 0.2 mm or less and more preferably 0.15 mm or less, and preferably 0.01 mm or more. The thickness of the brazing filler material is not limited especially when it is applied to any sheet material, and it is preferably 2 μm or more, and preferably 250 μm or less. The clad ratio of the brazing filler material is not limited especially, and it is preferably 40% or less.

### [Other Configurations of Aluminum Alloy Brazing Sheet]

Although the brazing sheet according to the present embodiment has been described along the configuration with the double-layer structure illustrated in FIG. 1 by way of example, it is noted that other configurations should not be excluded. For example, in a configuration of the brazing sheet according to the present embodiment, a sacrificial material (a sacrificial protection material) or an intermediate material may be provided on the other side (opposite side to the side where the brazing filler material 3 is provided) of the core material 2 illustrated in FIG. 1 in accordance with a request of a user. In addition, a brazing filler material may be further provided on the other side of the core material 2. In addition, a sacrificial material or an intermediate material may be provided on the other side of the core material 2, and a brazing filler material may be provided further outside thereof. When the configuration of the brazing sheet according to the present embodiment is a configuration in which brazing filler materials are provided on the opposite sides of a core material, one of the brazing filler materials may be a brazing filler material that does not satisfy the matters used to specify the present invention (for example, an Al—Si alloy, an Al—Si—Zn alloy, an Al—Si—Mg alloy, etc. such as JIS 4045, 4047, 4343, etc.) as long as the other brazing filler material satisfies the matters used to specify the present invention. In addition, the brazing filler material that does not satisfy the matters used to specify the present invention may be brazed by using flux applied to the surface of the brazing filler material.

A well-known component composition that can exhibit sacrificial protection ability may be used as the sacrificial material. For example, pure aluminum of JIS 1000 series or an Al—Zn alloy of JIS 7000 series may be used. On the other hand, various aluminum alloys may be used as the intermediate material in accordance with required properties. Alloy numbers shown in the present description are based on JIS H 4000:2014 and JIS Z 3263:2002.

Next, a brazing method for the aluminum alloy brazing sheet according to the present embodiment will be described.

### [Brazing Method for Aluminum Alloy Brazing Sheet]

The brazing method for the aluminum alloy brazing sheet according to the present embodiment is a method of so-called fluxless brazing using no flux, in which heating is performed in an inert gas atmosphere under predetermined heating conditions.

### (Heating Condition: Temperature Rise Rate)

In a case where the temperature rise rate from 350° C. to 560° C. is lower than 1° C./min when the brazing sheet according to the present embodiment is heated (brazed), in this temperature rise process, Mg of the core material may be excessively diffused into the brazing filler material. Thus, it is likely that MgO may be generated in the surface of the brazing filler material, and as a result, there is a fear that brazeability may deteriorate. On the other hand, in a case where the temperature rise rate from 350° C. to 560° C. exceeds 500° C./min, in this temperature rise process, Mg of the core material is not diffused suitably into the brazing filler material. Thus, it is likely that the getter action may be insufficient, and as a result, there is a fear that brazeability may deteriorate. Accordingly, the temperature rise rate from 350° C. to 560° C. is preferably 1° C./min or more and 500° C./min or less.

In order to more surely avoid that diffused amount of Mg from the core material to the brazing filler material becomes an excessive amount, the temperature rise rate from 350° C. to 560° C. is preferably 10° C./min or more. In addition, in order to more surely avoid that the diffused amount of Mg from the core material to the brazing filler material is insufficient, the temperature rise rate from 350° C. to 560° C. is preferably 300° C./min or less. On the other hand, a temperature drop rate from 560° C. is not limited especially. For example, it may be set to be 5° C./min or more and 1,000° C./min or less.

The temperature rise rate from 560° C. to an actual heating temperature (predetermined highest reaching temperature within a range of heating temperature, which will be described later) is not limited especially, and may be set at a rate within the same range as the temperature rise rate from 350° C. to 560° C. In addition, the temperature drop rate from the actual heating temperature to 560° C. is not limited especially, and may be set at a rate within the same range as the temperature drop rate from 560° C.

### (Heating Conditions: Heating Temperature and Holding Time)

The heating temperature (brazing filler melting temperature) at which the brazing sheet according to the present embodiment is heated is 560° C. or more and 620° C. or less, where the brazing filler material can melt appropriately, and is preferably 580° C. or more and 620° C. or less. When the holding time in this temperature region is less than 10 seconds, it is likely that the time required for generating a brazing phenomenon (break of an oxide film, lowering of oxygen concentration in the atmosphere, and flow of molten brazing filler into a joint portion) may be insufficient. Accordingly, the holding time in the temperature region of 560° C. or more and 620° C. or less (preferably 580° C. or more and 620° C. or less) is preferably 10 seconds or more.

In order to more surely generate the brazing phenomenon, the holding time in the temperature region 560° C. or more and 620° C. or less (preferably in the temperature region 580° C. or more and 620° C. or less) is preferably 30 seconds or more, and more preferably 60 seconds or more. On the other hand, the upper limit of the holding time is not limited especially, and may be 1,000 seconds or less.

### (Inert Gas Atmosphere)

The atmosphere in which the brazing sheet according to the present embodiment is heated (brazed) is an inert gas atmosphere, such as a nitrogen gas atmosphere, an argon gas atmosphere, a helium gas atmosphere, or a mixed gas atmosphere in which a plurality of those gases are mixed. In addition, the inert gas atmosphere is preferably an atmosphere having oxygen concentration as low as possible. Specifically, the oxygen concentration is preferably 50 ppm or less, and more preferably 10 ppm or less. The brazing method for the aluminum alloy brazing sheet according to the present embodiment does not require a vacuum atmosphere but can be performed under normal pressure (atmospheric pressure)

Typically, before subjecting the brazing sheet according to the present embodiment to the heating (before the heating step), a member to be joined is assembled to abut against the brazing filler material of the brazing sheet (assembling step). In addition, before the assembling step, the brazing sheet may be formed into a desired shape and structure (forming step).

The brazing method for the brazing sheet (or the method for producing a structure in which a member to be joined is brazed with the brazing sheet) according to the present embodiment has been described above. Conditions known in the background art may be used as conditions that have not been explicitly stated. Not to say, the conditions may be changed suitably as long as the effect obtained by the aforementioned processing can be exhibited.

Next, a method for producing the aluminum alloy brazing sheet according to the present embodiment will be described.

### [Method for Producing Aluminum Alloy Brazing Sheet]

The method for producing the aluminum alloy brazing sheet according to the present embodiment is not limited especially. For example, it is produced by a known method for producing a clad material. An example thereof will be described below. First, aluminum alloys having each of component compositions for the core material and the brazing filler material are dissolved and cast, and further subjected to surface grinding (surface smoothing process of an ingot) and homogenizing if necessary to obtain ingots for each of those. The ingot for the brazing filler material is subjected to hot rolling until it reaches a predetermined thickness, and is combined with the ingot for the core material, and subjected to hot rolling by a usual method, so as to be formed into a clad material. After that, on the clad material, cold rolling and intermediate annealing if necessary are performed, and further, final cold rolling and final annealing if necessary are performed. It is preferable that the homogenizing is performed at 400 to 600° C. for 1 to 20 hours, and the intermediate annealing is performed at 300 to 450° C. for 1 to 20 hours. In addition, it is preferable that the final annealing is performed at 150 to 450° C. for 1 to 20 hours. When the final annealing is performed, the intermediate annealing may be omitted. In addition, a temper may be any one of H1n H2n, H3n, and O (JIS H 0001:1998).

The method for producing the aluminum alloy brazing sheet according to the present embodiment has been described above. Conditions known in the background art may be used as conditions that have not been explicitly stated in each of the aforementioned steps. Not to say, the conditions may be changed suitably as long as the effect obtained by the processing in each of the aforementioned steps can be exhibited.

### Examples

Next, the brazing method for the aluminum alloy brazing sheet according to the present embodiment will be specifically described by comparison between Examples that satisfy requirements of the present invention and Comparative Examples that do not satisfy the requirements of the present invention.

### [Production of Test Material]

Core materials having compositions shown in Table 1 were cast and homogenized at 500° C. for 10 hours, and opposite surfaces thereof were ground to predetermined thickness. In addition, brazing filler materials having compositions shown in Table 2 were cast and homogenized at 500° C. for 10 hours, and subjected to hot rolling to reach a predetermined thickness to produce a hot rolled sheet. The brazing filler material and the core material were combined and subjected to hot rolling to thereby obtain a clad material. After that, cold rolling was performed to reach a thickness of 0.3 mm (the clad ratio of the brazing filler material was 10%), followed by performing final annealing at 400° C. for 5 hours to thereby produce a brazing sheet (O-temper material) with a double-layer structure, for use as a test material.

Next, conditions of heating corresponding to brazing, and evaluation methods and evaluation criteria for evaluation of brazeability, evaluation of erosion resistance, evaluation of corrosion resistance, and evaluation of strength after brazing heating will be shown.

### [Heating Corresponding to Brazing]

Heating corresponding brazing was performed in a nitrogen atmosphere with an oxygen concentration of 10 ppm and under conditions of a temperature rise rate from 350° C. to 560° C. of 30° C./min, and a holding time within a range from 580° C. to 620° C. of 180 seconds. However, for test materials shown in Table 4, heating corresponding to brazing was performed under conditions shown in the same table.

The temperature rise rate from 560° C. to the highest reaching temperature was the same as the temperature rise rate from 350° C. to 560° C., and the temperature drop rate from the highest reaching temperature was 100° C./min for each test material.

### [Evaluation of Brazeability]

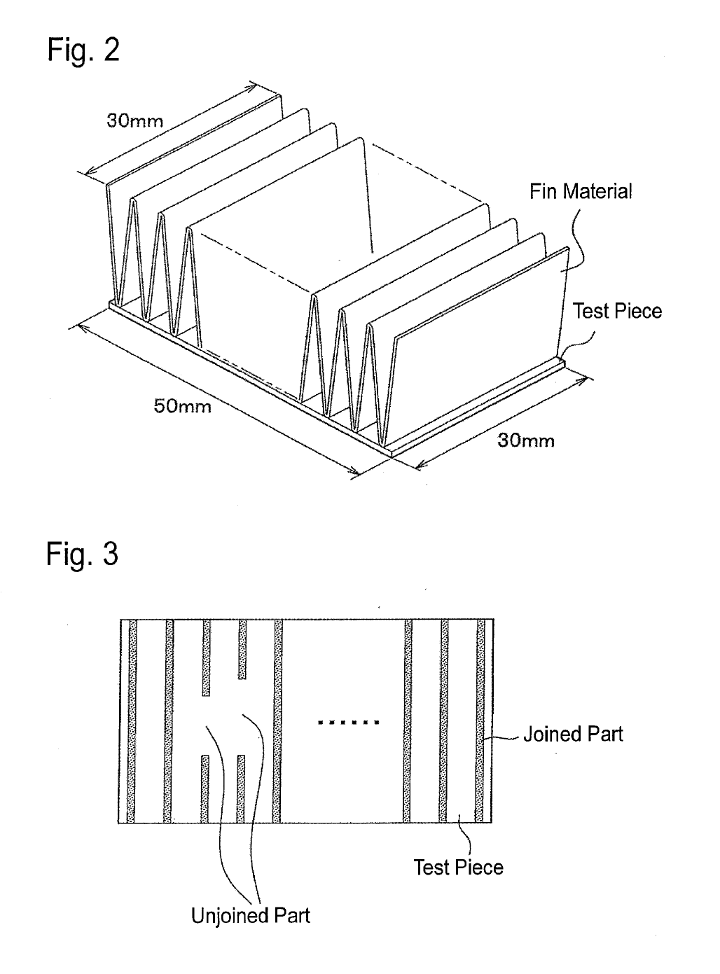

A test piece having a surface dimension of 50 mm×30 mm was cut out from each test material before heating corresponding to brazing. A bare fin material (JIS A3003, where sheet thickness was 100 μm, fin pitch was 3.5 mm, and the number of fin mountains abutting against the test piece was 15) was placed on a surface of a brazing filler material of the test piece (FIG. 2). Then, brazing joining was performed under the aforementioned conditions for heating corresponding to brazing. After brazing, the fin material was separated from the test piece, and an unjoined part was measured visually to calculate a joining ratio (=(total joining part length/(total joining part length+total unjoined part length))×100) (FIG. 3).

In the evaluation of brazeability, a test piece having a joining ratio of 95% or more was evaluated as “⋆”; one having a joining ratio of 90% or more and less than 95% was evaluated as “⊙”, one having a joining ratio of 80% or more and less than 90% was evaluated as “∘”; one having a joining ratio of 70% or more and less than 80% was evaluated as “Δ”; and one having a joining ratio less than 70% was evaluated as “x” “⋆”, “⊙”, “∘”, and “Δ” were evaluated as accept, and “x” was evaluated as reject.

Only the aforementioned evaluation of brazeability was performed on the test materials shown in Table 4. For the test materials shown in Table 3, the following evaluation of erosion resistance, the evaluation of corrosion resistance and the evaluation of strength after brazing heating were performed as well as the aforementioned evaluation of brazeability.

### [Evaluation of Erosion Resistance]

A test piece having a surface dimension of 2 cm×10 cm was cut out from each test material before heating corresponding to brazing. The aforementioned heating corresponding to brazing was performed in a state where the test piece was suspended with the longitudinal direction of the test piece set in a vertical direction (so-called drop test). After that, a central part (longitudinally and laterally central part) of the obtained test piece was cut to be 1 cm square, followed by burying into resin in a state where a cut surface located on the lower side during the heating corresponding to brazing looked upward so that the cut surface could be observed. The cut surface was polished and etched with a Keller's solution. The polished surface was observed with an optical microscope.

In the evaluation of erosion resistance, a test piece in which an area ratio of a core material part where erosion was not observed was 90% or more was evaluated as “└”; one whose area ratio was 80% or more and less than 90% was evaluated as “∘”; one whose area ratio was 70% or more and less than 80% was evaluated as “Δ”; and one whose area ratio was less than 70% was evaluated as “x”. “⊙”, “∘” and “Δ” were evaluated as accept, and “x” was evaluated as reject.

### [Evaluation of Corrosion Resistance]

A test piece having a surface dimension of 50 mm×50 mm was cut out from each test material after heating corresponding to brazing. For the test piece, the whole of a core material surface, the whole of an end surface and an outer edge region having a width of 5 mm in a brazing filler material surface were sealed with using a seal tape so that the brazing filler material side can serve as a test surface (40 mm×40 mm). The sealed test piece was immersed into OY water (Cl⁻: 195 ppm by mass, SO₄²⁻: 60 ppm by mass, Cu²⁺: 1 ppm by mass, Fe³⁺: 30 ppm by mass, pH: 3.0), and immersion test was performed for 20 days. In particular, in this immersion test, a series of flow in which the OY water was heated up from room temperature to 88° C. for 1 hour, held at 88° C. for 7 hours, cooled down to the room temperature for 1 hour, and held at the room temperature for 15 hours was performed repeatedly for 20 days by one cycle per day. After the immersion test, of the test surface, a region where corrosion was most conspicuous was sectionally observed by an optical microscope, and a corrosion form and a corrosion depth were obtained.

In the evaluation of corrosion resistance, a test piece having a corrosion depth of 20 μm or less was evaluated as “⊙”; one having a corrosion depth of more than 20 μm and 50 μm or less was evaluated as “∘”; one having a corrosion depth of more than 50 μm and 100 μm or less was evaluated as “Δ”, and one having a corrosion depth more than 100 μm was evaluated as “x”. “⊙”, “∘” and “Δ” were evaluated as accept, and “x” was evaluated as reject. The evaluation of corrosion resistance was not performed on ones evaluated as “x” in the evaluation of brazeability.

[Evaluation of Strength after Brazing Heating]

Each test material after the heating corresponding to brazing was held at the room temperature for 7 days. After that, a JIS No. 5 test piece was cut out from the test material so as to set a pulling direction in parallel with a rolling direction. By using the test piece, tensile test was performed at the room temperature according to JIS Z 2241:2011, and tensile strength was measured. It was performed at a cross head speed of 10 mm/minute, which was a fixed speed, until the test piece was broken.

In the evaluation of strength after brazing heating, a test piece of 220 MPa or more was evaluated as “*”; one of 200 MPa or more and less than 220 MPa was evaluated as “0”; one of 180 MPa or more and less than 200 MPa was evaluated as “0”; one of 160 MPa or more and less than 180 MPa was evaluated as “Δ”; and one of less than 160 MPa was evaluated as “x”. “⋆”, “⊙”, “∘”, and “Δ” were evaluated as accept, and “x” was evaluated as reject. The evaluation of strength after brazing heating was not performed on ones evaluated as “x” in the evaluation of brazeability.

Table 1 shows compositions of core materials, Table 2 shows compositions of brazing filler materials, Table 3 shows configurations of test materials and results of evaluation, Table 4 shows configurations of test materials, conditions of brazing and results of evaluation. The remainder of each core material in Table 1 and each brazing filler material in Table 2 are Al and unavoidable impurities, and “-” in the tables designates that the item was not contained (or equal to or less than a detection limit).

TABLE 1

| Core | Composition of core material (mass %) * | | | | | | | | |
|---|---|---|---|---|---|---|---|---|---|
| material No. | Mg | Cu | Si | Mn | Fe | Ti | Cr | Zr | Li |
| C1 | 1.2 | — | — | — | — | — | — | — | — |
| C2 | 0.6 | — | — | — | — | — | — | — | — |
| C3 | 2.2 | — | — | — | — | — | — | — | — |
| C4 | 1.2 | 0.2 | — | — | — | — | — | — | — |
| C5 | 1.1 | 0.4 | — | — | — | — | — | — | — |
| C6 | 1.2 | 0.8 | — | — | — | — | — | — | — |
| C7 | 1.1 | 0.3 | 0.9 | — | — | — | — | — | — |
| C8 | 1.1 | 0.2 | 0.8 | 1.4 | 0.7 | — | — | — | — |
| C9 | 1.3 | 0.3 | 0.2 | 1.1 | 0.4 | — | — | — | — |
| C10 | 1.1 | 0.4 | 0.4 | 1.2 | 0.2 | 0.2 | — | — | — |
| C11 | 1.3 | 0.1 | 0.5 | 0.8 | 0.2 | 0.1 | 0.2 | — | — |
| C12 | 1.2 | — | 0.3 | 1.4 | 0.4 | 0.1 | — | 0.2 | — |
| C13 | 1.2 | 1.1 | — | — | — | — | — | — | — |
| C14 | 1.2 | — | 1.1 | — | — | — | — | — | — |
| C15 | 1.1 | 0.3 | 0.5 | 1.3 | 0.2 | 0.1 | — | — | 0.15 |
| C16 | 0.3 | — | — | — | — | — | — | — | — |
| C17 | 2.8 | — | — | — | — | — | — | — | — |
| C18 | 0.3 | 0.3 | 0.4 | 1.5 | 0.3 | — | — | — | — |
| C19 | 2.7 | 0.2 | 0.5 | 1.0 | 0.2 | — | — | — | — |

* Remainder: Al and unavoidable impurities

TABLE 2

| Brazing filler | Components of composition of brazing filler material (mass %) * | | | | | | | | | | | | | | | | | |
|---|---|---|---|---|---|---|---|---|---|---|---|---|---|---|---|---|---|---|
| material No. | Si | Bi | Mg | Mn | Ti | Cr | Zr | Li | Zn | Sr | Na | Sb | Sc | Y | La | Ce | Nd | Dy |
| F1 | 10 | 0.30 | — | — | — | — | — | — | — | — | — | — | — | — | — | — | — | — |
| F2 | 4 | 0.40 | — | — | — | — | — | — | — | — | — | — | — | — | — | — | — | — |
| F3 | 7 | 0.50 | — | — | — | — | — | — | — | — | — | — | — | — | — | — | — | — |
| F4 | 13 | 0.40 | — | — | — | — | — | — | — | — | — | — | — | — | — | — | — | — |
| F5 | 9 | 0.10 | — | — | — | — | — | — | — | — | — | — | — | — | — | — | — | — |
| F6 | 11 | 0.80 | — | — | — | — | — | — | — | — | — | — | — | — | — | — | — | — |
| F7 | 10 | 0.40 | 0.04 | — | — | — | — | — | — | — | — | — | — | — | — | — | — | — |
| F8 | 10 | 0.40 | 0.09 | — | — | — | — | — | — | — | — | — | — | — | — | — | — | — |
| F9 | 8 | 0.25 | — | — | — | — | — | — | 3 | — | — | — | — | — | — | — | — | — |
| F10 | 12 | 0.30 | — | — | — | — | — | — | — | 0.02 | — | — | — | — | — | — | — | — |
| F11 | 11 | 0.25 | — | — | — | — | — | — | — | — | 0.003 | — | — | — | — | — | — | — |
| F12 | 10 | 0.50 | — | — | — | — | — | — | — | 0.01 | — | 0.2 | — | — | — | — | — | — |
| F13 | 9 | 0.10 | — | — | — | — | — | — | — | — | — | — | 0.4 | — | — | — | — | — |
| F14 | 9 | 0.10 | — | — | — | — | — | — | — | — | — | — | — | 0.3 | — | — | — | — |
| F15 | 9 | 0.10 | — | — | — | — | — | — | — | — | — | — | — | — | 0.1 | — | — | — |
| F16 | 9 | 0.10 | — | — | — | — | — | — | — | — | — | — | — | — | — | 0.6 | — | — |
| F17 | 9 | 0.10 | — | — | — | — | — | — | — | — | — | — | — | — | — | — | 0.2 | — |
| F18 | 9 | 0.10 | — | — | — | — | — | — | — | — | — | — | — | — | — | — | — | 0.4 |
| F19 | 9 | 0.10 | — | — | — | — | — | — | — | — | — | — | 0.1 | 0.2 | — | — | — | — |
| F20 | 9 | 0.10 | — | — | — | — | — | — | — | — | — | — | 0.3 | — | 0.1 | — | — | — |
| F21 | 9 | 0.10 | — | — | — | — | — | — | — | — | — | — | — | 0.05 | 0.1 | 0.1 | — | — |
| F22 | 9 | 0.10 | — | — | — | — | — | 0.03 | — | — | — | — | — | — | — | — | — | — |
| F23 | 9 | 0.10 | — | — | — | — | — | 0.01 | — | — | — | — | — | — | 0.1 | — | — | — |
| F24 | 9 | 0.10 | — | 1.0 | — | — | — | — | — | — | — | — | — | — | — | — | — | — |
| F25 | 9 | 0.10 | — | — | 0.1 | — | — | — | — | — | — | — | — | — | — | — | — | — |
| F26 | 9 | 0.10 | — | — | — | 0.2 | — | — | — | — | — | — | — | — | — | — | — | — |
| F27 | 9 | 0.10 | — | — | — | — | 0.1 | — | — | — | — | — | — | — | — | — | — | — |
| F28 | 9 | 0.10 | — | 0.6 | 0.1 | — | — | — | — | — | — | — | — | — | — | — | — | — |
| F29 | 9 | 0.10 | — | 0.2 | — | 0.1 | — | — | — | — | — | — | — | — | — | — | — | — |
| F30 | 10 | 0.30 | 0.15 | — | — | — | — | — | — | — | — | — | — | — | — | — | — | — |
| F31 | 10 | — | — | — | — | — | — | — | — | — | — | — | — | — | — | — | — | — |
| F32 | 10 | 1.20 | — | — | — | — | — | — | — | — | — | — | — | — | — | — | — | — |

* Remainder: Al and unavoidable impurities

TABLE 3

| | | | Evaluation | | | |
|---|---|---|---|---|---|---|
| Test | Core | Brazing filler | | Erosion | Corrosion | Strength after |
| material No. | material No. | material No. | Brazeability | resistance | resistance | brazing heating |
| A1 | C1 | F1 | ⋆ | ⊙ | Δ | ◯ |
| A2 | C2 | F1 | ⊙ | ⊙ | Δ | Δ |
| A3 | C3 | F1 | ⊙ | ◯ | Δ | ⊙ |
| A4 | C4 | F1 | ⋆ | ⊙ | ◯ | ⊙ |
| A5 | C5 | F1 | ⊙ | ◯ | ◯ | ⊙ |
| A6 | C6 | F1 | ◯ | Δ | ◯ | ⋆ |
| A7 | C7 | F1 | ◯ | Δ | ◯ | ⊙ |
| A8 | C8 | F1 | ⊙ | ◯ | ◯ | ⋆ |
| A9 | C9 | F1 | ⊙ | ◯ | ◯ | ⋆ |
| A10 | C10 | F1 | ⊙ | ◯ | ◯ | ⋆ |
| A11 | C11 | F1 | ⊙ | ◯ | ◯ | ⊙ |
| A12 | C12 | F1 | ⋆ | ⊙ | Δ | ⊙ |
| A13 | C8 | F2 | ◯ | ◯ | ◯ | ⋆ |
| A14 | C8 | F3 | ⊙ | ◯ | ◯ | ⋆ |
| A15 | C9 | F4 | ⊙ | ◯ | ◯ | ⋆ |
| A16 | C10 | F5 | Δ | ◯ | ◯ | ⋆ |
| A17 | C8 | F6 | ◯ | ◯ | ◯ | ⋆ |
| A18 | C9 | F7 | ◯ | ◯ | ◯ | ⋆ |
| A19 | C9 | F8 | Δ | ◯ | ◯ | ⋆ |
| A20 | C10 | F9 | ◯ | ◯ | ⊙ | ⋆ |
| A21 | C8 | F10 | ⊙ | ◯ | ◯ | ⋆ |
| A22 | C9 | F11 | ◯ | ◯ | ◯ | ⋆ |
| A23 | C10 | F12 | ⊙ | ◯ | ◯ | ⋆ |
| A24 | C10 | F13 | ◯ | ◯ | ◯ | ⋆ |
| A25 | C10 | F14 | ◯ | ◯ | ◯ | ⋆ |
| A26 | C10 | F15 | ◯ | ◯ | ◯ | ⋆ |
| A27 | C10 | F16 | ◯ | ◯ | ◯ | ⋆ |
| A28 | C10 | F17 | ◯ | ◯ | ◯ | ⋆ |
| A29 | C10 | F18 | ◯ | ◯ | ◯ | ⋆ |
| A30 | C10 | F19 | ◯ | ◯ | ◯ | ⋆ |
| A31 | C10 | F20 | ◯ | ◯ | ◯ | ⋆ |
| A32 | C10 | F21 | ◯ | ◯ | ◯ | ⋆ |
| A33 | C10 | F22 | ◯ | ◯ | ◯ | ⋆ |
| A34 | C10 | F23 | ◯ | ◯ | ◯ | ⋆ |
| A35 | C10 | F24 | Δ | ◯ | ⊙ | ⋆ |
| A36 | C10 | F25 | Δ | ◯ | ⊙ | ⋆ |
| A37 | C10 | F26 | Δ | ◯ | ⊙ | ⋆ |
| A38 | C10 | F27 | Δ | ◯ | ⊙ | ⋆ |
| A39 | C10 | F28 | Δ | ◯ | ⊙ | ⋆ |
| A40 | C10 | F29 | Δ | ◯ | ⊙ | ⋆ |
| A41 | C13 | F1 | ◯ | Δ | ◯ | ⋆ |
| A42 | C14 | F1 | ◯ | Δ | Δ | ⊙ |
| A43 | C15 | F1 | ⋆ | ◯ | ◯ | ⋆ |
| A44 | C15 | F22 | ◯ | ◯ | ◯ | ⋆ |
| A45 | C7 | F30 | Δ | Δ | ◯ | ⊙ |
| A46 | C16 | F1 | X | ⊙ | not evaluated | not evaluated |
| A47 | C17 | F1 | X | ◯ | not evaluated | not evaluated |
| A48 | C18 | F1 | X | ⊙ | not evaluated | not evaluated |
| A49 | C19 | F1 | X | Δ | not evaluated | not evaluated |
| A50 | C10 | F31 | X | ◯ | not evaluated | not evaluated |

| | | | |
|---|---|---|---|
| A51 | C10 | F32 | material could not be produced |

TABLE 4

| | | | Brazing conditions | | | |
|---|---|---|---|---|---|---|
| | | | Temperature | Holding time | | |
| | | | rise rate | in a range | | |
| | | | from 350° C. | from 580° C. | Oxygen | |
| Test | Core | Brazing filler | to 560° C. | to 620° C. | concentration | Evaluation |
| material No. | material No. | material No. | (° C./min) | (s) | (ppm) | Brazeability |
| B1 | C1 | F1 | 30 | 180 | 10 | ⋆ |
| B2 | C1 | F1 | 1 | 180 | 10 | ⊙ |
| B3 | C1 | F1 | 250 | 180 | 10 | ⋆ |
| B4 | C1 | F1 | 400 | 180 | 10 | ⊙ |
| B5 | C1 | F1 | 30 | 60 | 10 | ⋆ |
| B6 | C1 | F1 | 30 | 30 | 10 | ⊙ |
| B7 | C1 | F1 | 30 | 10 | 10 | ◯ |
| B8 | C1 | F1 | 30 | 180 | 40 | ◯ |

### [Analysis of Results]

Test materials A1 to A45 and B1 to B8 satisfied all the requirements specified in the present invention, resulting in accept about “brazeability”. Further, the test materials A1 to A45 also resulted in accept about all evaluations of “erosion resistance”, “corrosion resistance” and “strength after brazing heating”. However, in the test material A41 having a large content of Cu in the core material, the erosion resistance deteriorated a little (Δ). In addition, in the test material A42 having a large content of Si in the core material, the erosion resistance deteriorated a little (Δ). In addition, in the test material A45 having a large content of Mg in the brazing filler material, the brazeability deteriorated a little (Δ).

On the other hand, in test materials A46 to A51 that did not satisfy the requirements specified in the present invention, desired results could not be obtained. Detailed description will be made below.

In the test material A46 having a small content of Mg in the core material, it is supposed that the getter action was insufficient, resulting in “x” about brazeability. In the test material A47 having a large content of Mg in the core material, it is supposed that Mg diffused from the core material into the brazing filler material could not be trapped sufficiently by Bi of the brazing filler material to thereby promote generation of MgO in the surface of the brazing filler material, resulting in “x” about brazeability.

In the test material A48 having a small content of Mg in the core material, it is supposed that the getter action was insufficient, resulting in “x” about brazeability. In the test material A49 having a large content of Mg in the core material, it is supposed that Mg diffused from the core material into the brazing filler material could not be trapped sufficiently by Bi of the brazing filler material to thereby promote generation of MgO in the surface of the brazing filler material, resulting in “x” about brazeability.

In the test material A50 containing no Bi in the brazing filler material, it is supposed that Mg diffused from the core material into the brazing filler material reached the surface of the brazing filler material to thereby promote generation of MgO, resulting in “x” about brazeability. In the test material A51 having a large content of Bi in the brazing filler material, hot rolling cracks occurred in the material production step so that the material could not be produced.

From the above results, it can be confirmed that in the brazing method for the aluminum alloy brazing sheet according to the present invention, excellent brazeability can be exhibited while excellent erosion resistance, excellent corrosion resistance and strength after brazing heating can be also exhibited.

While the present invention has been described in detail and with reference to specific embodiments thereof, it will be apparent to one skilled in the art that various changes and modifications can be made therein without departing from the spirit and scope of the present invention. The present application is based on a Japanese patent application (Application No. 2016-244919) filed on Dec. 16, 2016 and a Japanese patent application (Application No. 2017-072549) filed on Mar. 31, 2017, the whole thereof being incorporated herein by reference.

### DESCRIPTION OF REFERENCE NUMERALS

1 aluminum alloy brazing sheet (brazing sheet)
2 core material
3 brazing filler material

1. A brazing method for an aluminum alloy brazing sheet including a core material and a brazing filler material provided in one surface of the core material, wherein:
the core material comprises an aluminum alloy comprising Mg: more than 0.5 mass % and 2.5 mass % or less, and the brazing filler material comprises an aluminum alloy comprising Si: 3 mass % or more and 13 mass % or less and Bi: 0.01 mass % or more and 1.00 mass % or less; and
the brazing method comprises brazing the aluminum alloy brazing sheet in an inert gas atmosphere at a heating temperature of 560 to 620° C. without using a flux.

2. The brazing method for the aluminum alloy brazing sheet according to claim 1, wherein the aluminum alloy of the brazing filler material further comprises any one or more of the following (a) to (f):
(a) Mg: 0.10 mass % or less;
(b) one or more kinds of Mn: 2.0 mass % or less, Ti: 0.3 mass % or less, Cr: 0.3 mass % or less, and Zr: 0.3 mass % or less;
(c) Li: 0.3 mass % or less;
(d) Zn: 5.0 mass % or less;
(e) one or more kinds of Sr: 0.10 mass % or less, Na: 0.050 mass % or less and Sb: 0.5 mass % or less; and
(f) a rare earth element: 1.0 mass % or less.

3. The brazing method for the aluminum alloy brazing sheet according to claim 1, wherein the aluminum alloy of the core material further comprises any one or more of the following (a) to (f):
(a) Cu: 1.0 mass % or less;
(b) Si: 1.0 mass % or less;
(c) Mn: 2.5 mass % or less;
(d) Fe: 1.5 mass % or less;
(e) one or more kinds of Ti: 0.5 mass % or less, Cr: 0.5 mass % or less and Zr: 0.5 mass % or less; and
(f) Li: 0.3 mass % or less.

4. The brazing method for the aluminum alloy brazing sheet according to claim 2, wherein the aluminum alloy of the core material further comprises any one or more of the following (a) to (f):
(a) Cu: 1.0 mass % or less;
(b) Si: 1.0 mass % or less;
(c) Mn: 2.5 mass % or less;
(d) Fe: 1.5 mass % or less;
(e) one or more kinds of Ti: 0.5 mass % or less, Cr: 0.5 mass % or less and Zr: 0.5 mass % or less; and
(f) Li: 0.3 mass % or less.
